(19) United States
(12) Patent Application Publication
(10) Pub. No.: US 2018/0034972 A1
(43) Pub. Date: Feb. 1, 2018

(54) System and method for call termination based on an over-the-top (OTT) call service of a calling party

(71) Applicant: Tata Communications (America) Inc., Herndon, VA (US)

(72) Inventor: Avanish Pande, Spotswood, NJ (US)

(21) Appl. No.: 15/551,574

(22) PCT Filed: Feb. 18, 2016
(86) PCT No.: PCT/US2016/018399

§ 371 Date: Aug. 16, 2017

Related U.S. Application Data
(60) Provisional application No. 62/126,138, filed on Feb. 27, 2015.
(60) Provisional application No. 62/118,954, filed on Feb. 20, 2015.

(51) Int. Cl. H04M 7/12; H04W 4/00; H04W 40/12

(52) U.S. Cl. CPC H04M 7/128; H04W 40/12; H04W 4/001

(57) ABSTRACT

A system and method for connecting a call from an originating endpoint of a calling party to a terminating endpoint of a called party while accounting for whether the calling party is using an over-the-top (OTT) call service. In response to receiving a dialed number, or other call information, a computer system determines whether to connect the call to the terminating endpoint of the called party via an OTT call service, or not, based on the geolocation of the originating endpoint. For example and without limitation, based on the originating endpoint currently being located within a country that is on a list of developed countries or not currently being located within a country that is on a list of developing countries, the computer system might deem a particular OTT call service to be acceptable for handling the call for the terminating endpoint.

### CROSS REFERENCE TO RELATED APPLICATIONS

The following U.S. provisional applications are incorporated herein by reference: U.S. Patent Application Ser. No. 62/118,954, filed Feb. 20, 2015 and U.S. Patent Application Ser. No. 62/126,138, filed Feb. 27, 2015. If there are any contradictions or inconsistencies in language between this application and the provisional applications that have been incorporated by reference that might affect the interpretation of the claims in this application, the claims in this application should be interpreted to be consistent with the language in this application.

This application is also related to “System and method for call termination based on one or more over-the-top (OTT) call services,” Application Serial Number PCT2016/______, Attorney Docket 2449-161wo1, filed on the same day as the present application and incorporated by reference in its entirety.

### FIELD OF THE INVENTION

The present invention relates to telecommunications in general, and, more particularly, to connecting a call from an originating endpoint of a calling party to a terminating endpoint of a called party while accounting for an over-the-top (OTT) call service that is being used by the calling party.

### BACKGROUND OF THE INVENTION

Over-the-top (OTT) services in general include a wide range of content delivery through software applications running on user devices and through third-party services that are independent of the underlying communication infrastructure technology. An OTT call service in particular delivers at least one of voice, messaging, and video services to its subscribers. Some examples of OTT call services are Skype, Google Hangouts, Viber, WeChat, Facebook Messenger, Apple Facetime, WhatsApp, and SnapChat.

From an end-user subscriber's perspective, an OTT service is received over the Internet, but delivery is not controlled (e.g., switched, etc.) directly by the end-user's local service provider, which merely acts as a data “pipe” in this case. Accordingly, OTT service is accessed directly through an Internet-connected user device, which is also referred to as an “endpoint,” such as a personal computer, laptop, tablet, smartphone, or other web-enabled device.

In regard to connecting a call from an originating endpoint of a calling party to a terminating endpoint of a called party, a telecommunications system that includes one or more OTT call services provides additional flexibility as to how the call may be connected. The complexity, however, of the telecommunications system also increases. For example, the telecommunications system has to also account for whether the calling party or called party, or both, is using an OTT call service to handle their calls.

Techniques exist in the prior art that attempt to address how to connect a calling party to a called party who is subscribed to an OTT call service. For example, WO 2014/087269 A1 discloses a method for connecting OTT resources and traditional telecommunications networks to each other. In the disclosed method, an OTT call service checks whether connectivity to a called party's OTT application is adequate by performing a performance test, by sending a small number of packets as fast as it can, for example. If performance is inadequate, the OTT call service rejects the call.

### SUMMARY OF THE INVENTION

The present invention enables the connecting of a call from an originating endpoint of a calling party to a terminating endpoint of a called party while accounting for whether the calling party is using an over-the-top (OTT) call service. In response to receiving a dialed number, or other call information, a computer system of the illustrative embodiment determines whether to connect the call to the terminating endpoint of the called party via an OTT call service, or not, based on the geolocation of the originating endpoint. For example and without limitation, based on the originating endpoint currently being located within a country that is on a list of developed countries or not currently being located within a country that is on a list of developing countries, the computer system might deem a particular OTT call service to be acceptable for handling the call for the terminating endpoint. Otherwise, the computer system directs the call to be routed to a terminating endpoint via the dialed number and switched via the terminating endpoint's local telecommunications service provider and access network. In some embodiments of the present invention, the geolocation of the terminating endpoint can be considered in the aforementioned way as well.

In some embodiments of the present invention, one or more predetermined characteristics of the access network of the originating endpoint are assessed, as part of a determination of the quality that might be experienced if the call were to be handled not only via the calling party's OTT call service but in addition via an OTT call service of the called party. As part of determining an overall quality score, the fact that the originating endpoint has access to a 3G mobile network in a developed country merits a higher quality score than having access to a 3G mobile network in a developing country. One reason for scoring a 3G mobile network—or any given generation of mobile network, for that matter—higher in a developed country is that the mobile network coverage and performance in a developed country tends to be more consistent than in a developing country. The quality score can also be based on other factors such as whether the originating endpoint has access to a WiFi network, for example and without limitation. Given that the calling party is already using an OTT service, provided that the quality score is sufficient, the computer system of the illustrative embodiment can direct that the call be routed to the selected OTT call service of the terminating endpoint. In some other embodiments of the present invention, the basic indication of whether the originating endpoint is using an OTT call service or not determines whether to route to the dialed number or, possibly, to an OTT call service of the called party, respectively.

The call handling technique of the illustrative embodiment is advantageous, in that by considering the call quality being experienced by the originating endpoint that is already using an OTT call service, the technique provides a straightforward way, with little or no additional overhead, to provide a representation of whether the quality is good enough also to involve an OTT call service of the called party in delivering a call. For example, if both the originating and terminating endpoints were to use OTT call services while operating in networks of inconsistent quality, then the call quality perceived by the parties on the call might be judged unacceptable; where this would be the case, the call is instead routed to the terminating endpoint via the dialed number and switched via the terminating endpoint's local telecommunications service provider and access network. Furthermore, when used in a telecommunications system that by default routes calls via the dialed number and through the local telecommunications network of the called party, the technique of the illustrative embodiment enables new revenues to be generated for OTT service suppliers and, for OTT subscribers, enables cost savings in roamer networks.

An illustrative system for connecting a call from an originating endpoint of a calling party to a terminating endpoint of a called party comprises: a computer system configured to: receive a dialed number for the call when placed from the originating endpoint, determine an over-the-top (OTT) call service subscribed to by the called party, wherein the OTT call service of the called party is accessible from the terminating endpoint via the Internet, and generate a signal for controlling the call, wherein the signal indicates to route the call i) via the dialed number such that the call is switched via the terminating endpoint's local telecommunications service provider and access network or ii) via the OTT call service of the called party, based on whether the call is placed from the originating endpoint through an OTT call service of the calling party; and a networking device configured to route the call to the terminating endpoint, based on the signal.

An illustrative method for connecting a call from an originating endpoint of a calling party to a terminating endpoint of a called party comprises: receiving, by a computer system, a dialed number for the call when placed from the originating endpoint; determining, by the computer system, an over-the-top (OTT) call service subscribed to by the called party, wherein the OTT call service of the called party is accessible from the terminating endpoint via the Internet; generating, by the computer system, a signal for controlling the call, wherein the signal indicates to route the call i) via the dialed number such that the call is switched via the terminating endpoint's local telecommunications service provider and access network or ii) via the OTT call service of the called party, based on whether the call is placed from the originating endpoint through an OTT call service of the calling party; and routing the call to the terminating endpoint based on the signal.

Another illustrative system for connecting a call from an originating endpoint of a calling party to a terminating endpoint of a called party comprises: a computer system configured to: receive a dialed number for the call when placed from the originating endpoint through an over-the-top (OTT) call service of the calling party accessed from the originating endpoint via a first access network, determine an OTT call service subscribed to by the called party, and generate a signal for controlling the call, wherein the signal indicates to route the call i) via the dialed number such that the call is switched via the terminating endpoint's local telecommunications service provider and access network or ii) via the OTT call service of the called party, based on a first predetermined characteristic of the first access network; and a networking device configured to route the call, based on the signal.

Another illustrative method for connecting a call from an originating endpoint of a calling party to a terminating endpoint of a called party comprises: receiving, by a computer system, a dialed number for the call when placed from the originating endpoint through an over-the-top (OTT) call service of the calling party accessed from the originating endpoint via a first access network; determining, by the computer system, an OTT call service subscribed to by the called party; generating, by the computer system, a signal for controlling the call, wherein the signal indicates to route the call i) via the dialed number such that the call is switched via the terminating endpoint's local telecommunications service provider and access network or ii) via the OTT call service of the called party, based on a first predetermined characteristic of the first access network; and routing the call to the terminating endpoint based on the signal.

### BRIEF DESCRIPTION OF THE DRAWINGS

FIG. 1 depicts telecommunications system 100, in accordance with the illustrative embodiment of the present invention.

FIG. 2 depicts Internet network 101 within telecommunications system 100.

FIG. 3 depicts a block diagram of the salient components of computer system 221 within central IP network 220 of Internet network 101.

FIG. 4 depicts a message flow diagram of the salient processes for routing a call, based on one or more predetermined characteristics in an access network of the called party.

FIG. 5 depicts a message flow diagram of the salient processes for routing a call, based on one or more predetermined characteristics in an access network of the calling party.

FIG. 6 depicts a message flow diagram of the salient processes for routing a call, in which the call can be routed through one of multiple OTT call services of the called party.

FIG. 7 depicts at least some of the salient tasks associated with method 700, in accordance with the illustrative embodiment of the present invention.

FIG. 8 depicts at least some of the salient subtasks associated with task 715 of method 700.

FIG. 9 depicts a database in which computer system 221 stores and maintains the values of at least some of the parameters used in determining whether to use an OTT service to deliver a call.

FIG. 10 depicts at least some of the salient subtasks associated with task 730 of method 700.

FIG. 11 depicts at least some of the salient subtasks associated with task 740 of method 700.

FIG. 12 depicts at least some of the salient subtasks associated with task 745 of method 700.

### DETAILED DESCRIPTION

Based on—For the purposes of this specification, the phrase “based on” is defined as “being dependent on” in contrast to “being independent of”. The value of Y is dependent on the value of X when the value of Y is different for two or more values of X. The value of Y is independent of the value of X when the value of Y is the same for all values of X. Being “based on” includes both functions and relations.

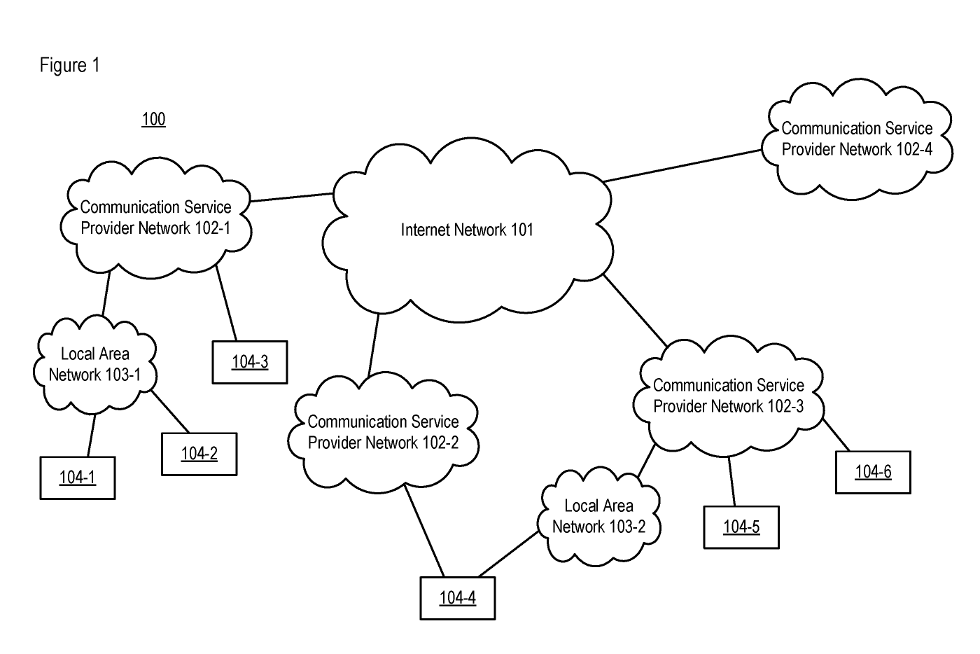

FIG. 1 depicts telecommunications system 100, in accordance with the illustrative embodiment of the present invention. Telecommunications system 100 comprises Internet network 101, communication service provider networks 102-1 through 102-4, local area networks 103-1 and 103-2, and telecommunication endpoints 104-1 through 104-6, interrelated as shown.

Internet network 101 comprises at least a portion of the Internet, the global system of interconnected computer networks that use the Internet protocol suite (TCP/IP) to link billions of user devices and networking devices worldwide. Internet network 101 comprises a plurality of Internet service provider (ISP) networks of various forms. An ISP is an organization that provides services for accessing, using, and/or participating in the Internet. An ISP provides services for accessing, using, and/or participating in the Internet, through its communications network. Some of the more specific classifications of an ISP network is “local”, “tier 2”, and “tier 1”, as described elsewhere in this specification.

Internet network 101 comprises computer- and/or telecommunications-networking devices, which can include gateways, routers, network bridges, switches, hubs, and repeaters. The networking devices that constitute the networks depicted in FIG. 1 can also include hybrid network devices such as multilayer switches, protocol converters, bridge routers, proxy servers, firewalls, network address translators, multiplexers, network interface controllers, wireless network interface controllers, modems, ISDN terminal adapters, line drivers, wireless access points, networking cables, and other related hardware. At least some of the networking devices that are present in Internet network 101, as well as elsewhere within telecommunications system 100, use routing tables in their operating system to direct IP packets to the next-hop router or destination. Routing tables are maintained by manual configuration or automatically by routing protocols.

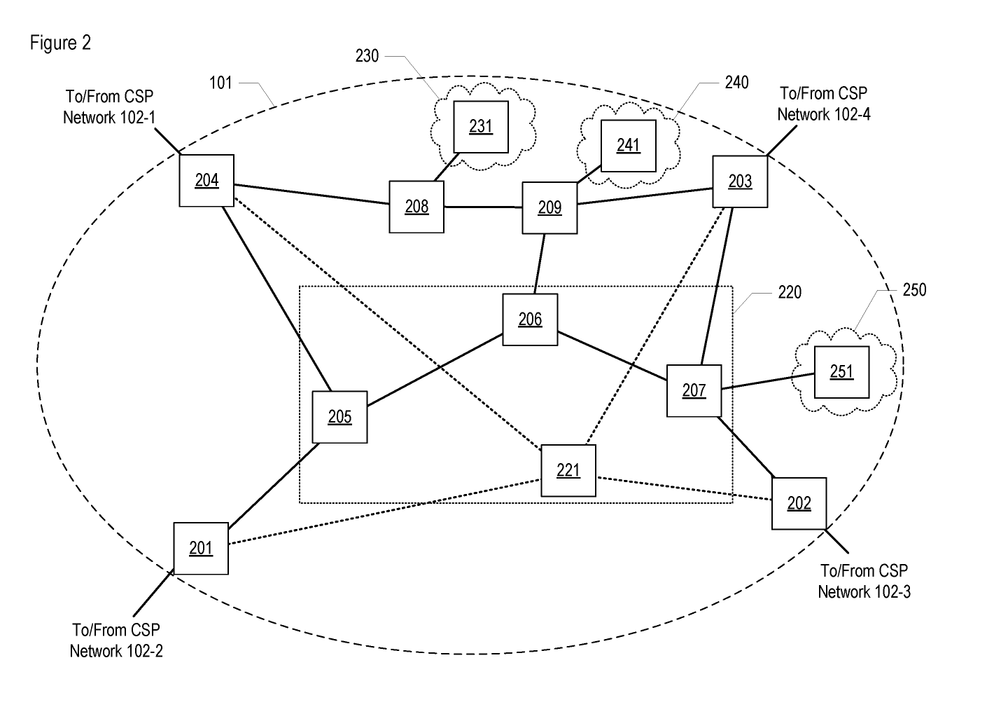

Internet service providers whose networks constitute Internet network 101, as well as other elements within telecommunications system 100, establish the worldwide connectivity between individual networks at various levels of scope. At the bottom of the Internet routing hierarchy are those telecommunications endpoints 104-1 through 104-6 that can access the Internet. At the top of the Internet routing hierarchy are the tier 1 networks, including tier-1 network 220 described below and with respect to FIG. 2, large telecommunication companies that exchange traffic directly with each other via peering agreements. In at least some embodiments of the present invention, a tier 1 network can reach every other network on the Internet without purchasing IP transit or paying settlements; by this definition, a tier 1 network is a transit-free network that peers with every other tier 1 network. Tier 2 and lower level networks buy Internet transit from other providers to reach at least some parties on the global Internet, though they might also engage in peering. An Internet service provider may use a single upstream provider for connectivity, or implement multihoming to achieve redundancy and load balancing. Internet exchange points are major traffic exchanges with physical connections to multiple Internet service providers.

Communication service provider (CSP) network 102-i, wherein i as depicted has a value of between 1 and 4, inclusive, is a network that transports information electronically. In accordance with the illustrative embodiment of the present invention, CSP network 102-i is that of a telecommunications service provider (TSP). A TSP can be an incumbent local exchange carrier, a competitive local exchange carrier, and/or a mobile wireless communication company, for example and without limitation. In some embodiments of the present invention, CSP network 102-i can include or alternatively be the network of an Internet provider, a cable provider, a satellite provider, or a managed services business provider, for example and without limitation.

Communication service provider (CSP) network 102-i provides user devices of its end users—for example, endpoints 104-1 through 104-6—with access to Internet network 101. Communication service provider (CSP) network 102-i can also provide each endpoint with connectivity to one or more other endpoints, either through Internet network 101 or not. In some operating environments, CSP network 102-i provides such access to a local area network (LAN), which in turn provides access to the end user. As depicted, the communication provider networks are outside of Internet network 101. In some other embodiments, however, one or more of the communication service provider networks can be considered as part of Internet network 101 (e.g., some local Internet service provider networks, etc.).

Each CSP network 102-i comprises computer- and/or telecommunications-networking devices, which can include gateways, routers, network bridges, switches, hubs, and repeaters. The networking devices that constitute the networks depicted in FIG. 1 can also include hybrid network devices such as multilayer switches, protocol converters, bridge routers, proxy servers, firewalls, network address translators, multiplexers, network interface controllers, wireless network interface controllers, modems, ISDN terminal adapters, line drivers, wireless access points, networking cables, and other related hardware. Furthermore, each CSP network provides endpoints with access via one or more access networks. An “access network” is the part of a telecommunications network that connects endpoints to their immediate service provider network, in this case CSP network 102-i. The access networks conform to one or more telecommunications standards. Some examples of such telecommunications standards include, without limitation: Global System for Mobile Communications (GSM), Universal Mobile Telecommunications System (UMTS), Long Term Evolution (LTE), CDMA-2000, IS-136 TDMA, IS-95 CDMA, 3G Wideband CDMA, IEEE 802.11 Wi-Fi, IEEE 802.16 WiMax, Bluetooth, LoRa, and so on. In at least some operating environments, the access network directly used by such endpoints is privately owned or maintained (e.g., a home LAN, a business enterprise, etc.), and is connected to the CSP network via a networking device (e.g., a router, etc.) associated with the private network.

Although four communication service provider networks are depicted, a different number of such networks can be present, as those who are skilled in the art will appreciate after reading this specification.

Local area network (LAN) 103-j, wherein j as depicted has a value of 1 or 2, is a computer network that interconnects computers (e.g., endpoint 104-1, endpoint 104-2, endpoint 104-4, etc.) within a limited area (e.g., residence, office building, school, etc.). LAN 103-j is based on a communication protocol such as, while not being limited to, Ethernet or WiFi.

Although two local area networks are depicted, a different number of such networks can be present, as those who are skilled in the art will appreciate after reading this specification.

Telecommunication endpoint 104-k, wherein k as depicted has a value of between 1 and 6, inclusive, is a user device that enables its user (e.g., human, machine, etc.) to telecommunicate with resources within Internet network 101, with other endpoints, and/or with other resources within telecommunications system 100. Endpoint 104-k is capable of telecommunications with or without a wire or tangible medium, such that some endpoints are wired, some endpoints are wireless, and some are both, in any combination. An endpoint can be mobile or immobile, and an endpoint can transmit or receive, or transmit and receive. An endpoint can be a wireless terminal, a cellular telephone or cellphone, a wireless transmit/receive unit (WTRU), a user equipment (UE), a mobile station, a fixed or mobile subscriber unit, a pager, a personal digital assistant (PDA), a smartphone, a smart watch, a desk set, a computer, or any other type of end-user device capable of operating in a telecommunications environment, for example and without limitation.

Endpoint 104-k is capable of providing access to its user via one or more access networks, as described above and in regard to CSP network 102-i. At least some endpoints are capable of communication via both a cellular access network and a LAN access network; such an endpoint is endpoint 104-4 as depicted, for example and without limitation. As already described, some examples of access networks include networks based on the following telecommunications standards, without limitation: Global System for Mobile Communications (GSM), Universal Mobile Telecommunications System (UMTS), Long Term Evolution (LTE), CDMA-2000, IS-136 TDMA, IS-95 CDMA, 3G Wideband CDMA, IEEE 802.11 Wi-Fi, IEEE 802.16 WiMax, Bluetooth, LoRa, and so on.

Although six telecommunication endpoints are depicted in FIG. 1, a different number of such endpoints can be present, as those who are skilled in the art will appreciate after reading this specification. Furthermore, a different number than depicted can be associated with each communication service provider network 102-i and local area network 103-j. One or more endpoints can be associated with a given end user; in some embodiments of the present invention, a particular call can be delivered to a called party i) via a first endpoint and in accordance with a first outcome of the techniques disclosed herein, and/or ii) via a second endpoint and in accordance with a second outcome, as described below.

At least some of the endpoints depicted in FIG. 1 are capable of executing one or more over-the-top (OTT) applications or “apps”. An OTT app enables the endpoint, and thus its user, to access the corresponding OTT call service, as a called party or a calling party in a given call. By processing a call via an OTT app, an endpoint uses the CSP network infrastructure to access the Internet, in order to access the corresponding OTT call service to complete the call. This is, in contrast, to the endpoint relying directly on the host CSP network itself to handle at least some of the call control and switching of the call. In other words, an OTT-based call is transparent to the host CSP network, other than for providing data exchange between the endpoint and the Internet-based OTT call service platform.

FIG. 2 depicts Internet network 101 within telecommunications system 100. Internet network 101 comprises one or more tier-level service provider networks, including central IP network 220. Each service provider network in Internet network 101 comprises one or more computer networking devices (e.g., routers, etc.). As depicted, Internet network 101 comprises routers 201 through 209 and various computer systems (e.g., server computers, etc.), interconnected as shown. Although nine routers are depicted, network 101 can comprise any number of routers and networking devices in general.

Central IP network 220 serves as a central connection for at least some of the OTT call services provided within telecommunications system 100, in accordance with the illustrative embodiment of the present invention. As described below, computer system 221 within network 220 provides at least some of the call control for connecting a call from an originating endpoint of a calling party to a terminating endpoint of a called party while accounting for one or more OTT call services that are subscribed to by the called party. Additionally, computer system 221 can also account for whether the calling party is using an OTT call service to place the call. For example and without limitation, computer system 221 can direct a call originated via a non-OTT call service or an OTT call service of the calling party, to a terminating endpoint via either a non-OTT call service or an OTT call service of the called party, based on one or more considerations that are disclosed herein.

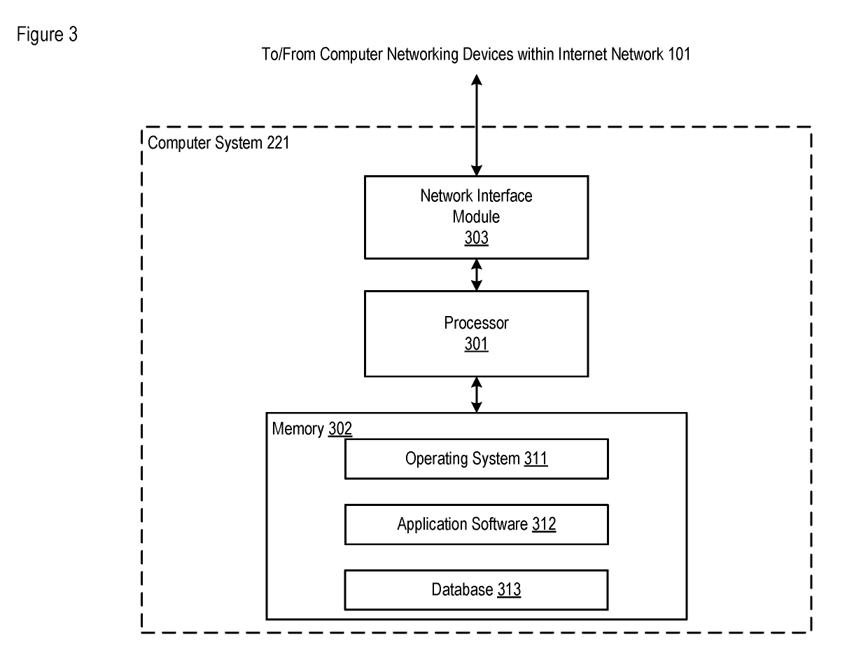

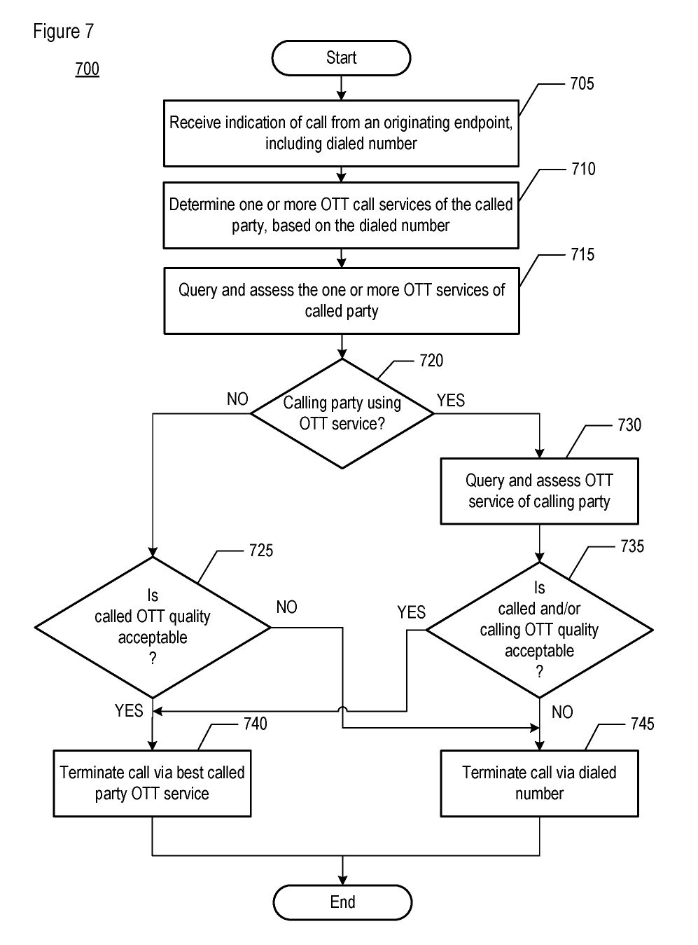

Central IP network 220 comprises computer system 221 and routers 205 through 207. As described below and with respect to FIG. 3, computer system 221 comprises a server computer and performs at least some of the controlling tasks depicted in FIG. 7 and later. Although three routers are depicted, network 220 can comprise any number of routers and networking devices in general. Furthermore, in some alternative embodiments of the present invention, a first and second networking device that are part of a given service provider network (e.g., network 220, etc.) might be separated by at least one networking device belonging to a different service provider network, through which one or more data packets must pass to get from the first networking device to the second.

As depicted, at least one computer-networking device is arranged between a networking device in network 220 and a CSP network 102-i, wherein the intermediate computer-networking device belongs to a different service provider network than network 220. For example and without limitation, router 201 is arranged between router 205 and communication service provider network 102-2. As those who are skilled in the art will appreciate after reading this specification, however, there can be any number of such intermediate devices, or no intermediate device at all, between network 220 and a CSP network 102-i, in various combinations between network 220 and the various CSP networks 102. Furthermore, where there are multiple intermediate devices between network 220 and a particular CSP network 102-i, different sets of these intermediate devices can belong to different service provider networks.

In accordance with the illustrative embodiment, network 220 is a tier 1 IP network. In some alternative embodiments of the present invention, however, network 220 can be a different type of service provider network, such as a tier 2 IP network, for example and without limitation. Furthermore, in some embodiments of the present invention, central IP network 220 can also serve as a backbone Internet service provider network as is known in the art and, as such, can be referred to as a “backbone service provider network.”

IP network 220 is capable of coordinating quality-of-service- (QoS-) enabled IP service for traffic prioritization throughout Internet network 101, in some embodiments of the present invention. As video and voice are latency-sensitive applications, it is inefficient to give file-sharing and email applications the same priority in the delivery. IP network 220 enables Internet network 101 to provide video, voice, and other latency-sensitive applications higher QoS to improve the network utility.

IP network 220 is further capable of coordinating managed encryption throughout Internet network 201, in some embodiments of the present invention. Secure communications can be achieved through traditional security technology, such as IPSec, or through other means. For traditional IPSec deployment, IP network 220 manages all the customer connections and managed routers. For non-entity country sites, IP network 220 manages the overall provisioning, fault reporting, trouble-shooting co-ordinations and billing as a complete managed service. IP network 220 is responsible for the overall IPSec tunnel configuration and on-going maintenance. This extends to support IPSec VPN clients running on PCs/Laptops, tablets, and smartphones. The managed encryption service provides tunnel-less encryption without encrypting the IP header to preserve the IP header information. The managed encryption platform can support regular key renewal mechanism to further increase the security level of the packets between two enterprise network endpoints.

Internet network 101 further comprises OTT call service platforms 230, 240, and 250, which provide the “OTT A” service, “OTT B” service, and “OTT C” service, respectively. Some examples of OTT call services are Skype, Google Hangouts, Viber, WeChat, Facebook Messenger, Apple Facetime, WhatsApp, and SnapChat, for example and without limitation. Each service platform comprises a computer system comprising one or more server computers on which the respective OTT call service is hosted. Computer systems 231, 241, and 251 are part of platforms 230, 240, and 250, respectively.

Although service platforms for three OTT call services are depicted, a different number of such services can be supported within Internet network 101, as those who are skilled in the art will appreciate after reading this specification. Furthermore, although service platforms 230, 240, and 250 are depicted as being outside of IP network 220 and within Internet network 101, one or more service platforms can be situated within network 220. Also, one or more service platforms can be situated outside of Internet network 101, such as within a CSP network 102-i.

In accordance with the illustrative embodiment of the present invention, central computer system 221 and OTT call service platforms 230, 240, and 250 perform different functions. That is, central computer system 221 coordinates the connecting of calls as described below, but does not itself host any OTT call service, while platforms 230, 240, and 250 host OTT call services, but do not perform the call-connecting functions of computer system 221.

FIG. 3 depicts a block diagram of the salient components of computer system 221 within central IP network 220, in accordance with the illustrative embodiment of the present invention. Computer system 221 comprises: processor 301, memory 302, and network interface module 303, which are interconnected as shown.

Computer system 221 comprises at least one server computer that performs at least some of the tasks disclosed herein. As those who are skilled in the art will appreciate after reading this specification, the hardware platform performing at least some of the tasks performed by computer system 221 can be embodied as a multi-processor platform, as a sub-component of a larger computing platform, as a virtual computing element, or in some other computing environment—all within the scope of the present invention.

As those who are skilled in the art will appreciate after reading this specification, computer system 221 can be a different type of apparatus than a server computer, and can be referred to by a different name such as a data-processing system, a computing device, or another type of hardware platform that comprises one or more processors, one or more memories, and one or more network interfaces, for example and without limitation.

Processor 301 is a general-purpose processor that is configured to execute operating system 311 and application software 312, and to populate, amend, use, and manage database 313, as described in detail below and in the accompanying figures. For the purposes of this specification, a “processor” is defined as one or more computational elements, whether co-located or not and whether networked together or not.

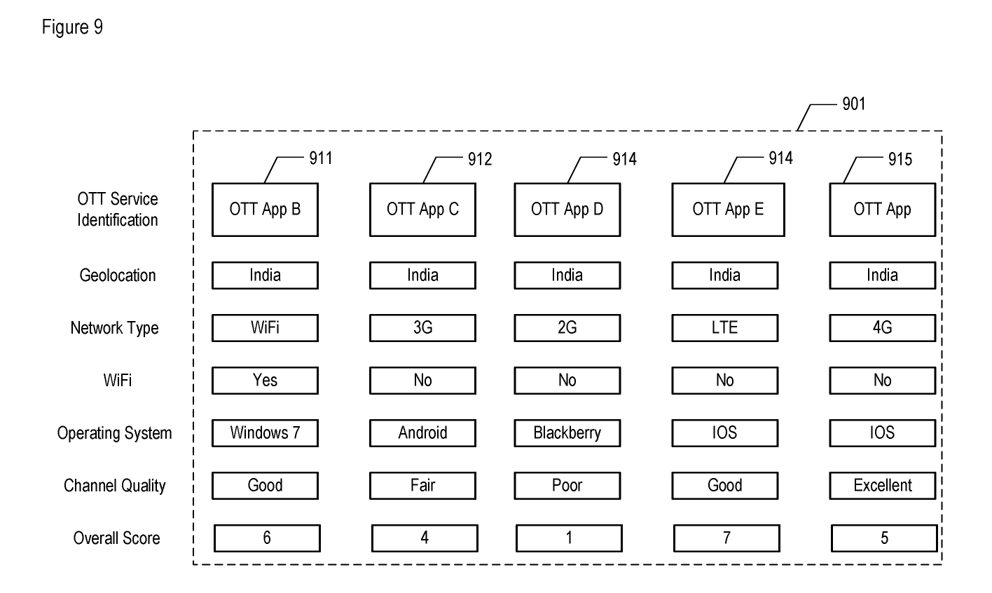

Memory 302 is non-transitory and non-volatile computer storage memory technology that is well known in the art (e.g., flash memory, etc.). Memory 302 is configured to store operating system 311, application software 312, and database 313. The operating system is a collection of software that manages computer system 221's hardware resources and provides common services for computer programs, such as those that constitute the application software. The application software that is executed by processor 301 enables computer system 221 to perform at least some of the functions disclosed herein. Database 313 comprises information for mapping a dialed number or other pointer, to one or more OTT call services, as described below, and the quality matrix described below and with respect to FIG. 9.

It will be clear to those having ordinary skill in the art how to make and use alternative embodiments that comprise more than one memory 302; or comprise subdivided segments of memory 302; or comprise a plurality of memory technologies that collectively store the operating system, application software, and database.

Network interface module 303 comprises a network adapter configured to enable computer system 221 to transmit information to and receive information from other parts of telecommunications system 100.

In regard to computer systems 231, 241, and 251, each of these computer systems is similar to computer system 221 described above and with respect to FIG. 3. Each of these computer systems comprises at least one server computer that performs at least some of the tasks disclosed herein. As those who are skilled in the art will appreciate after reading this specification, the hardware platform performing at least some of the tasks performed by one or more of computer systems 231, 241, and 251 can be embodied as a multi-processor platform, as a sub-component of a larger computing platform, as a virtual computing element, or in some other computing environment—all within the scope of the present invention.

As those who are skilled in the art will appreciate after reading this specification, any or all of computer systems 231, 241, and 251 can be a different type of apparatus than a server computer, and can be referred to by a different name such as a data-processing system, a computing device, or another type of hardware platform that comprises one or more processors, one or more memories, and one or more network interfaces, for example and without limitation.

Additionally, each OTT call service platform 230, 240, and 250 can comprise multiple hardware platforms (e.g., server computers, etc.) that are part of computer systems 231, 241, and 251, wherein each hardware platform performs a different subset of the tasks disclosed herein. For example and without limitation, within OTT call service platform 230, the function of providing an OTT call service can be performed by any combination of one or more hardware platforms.

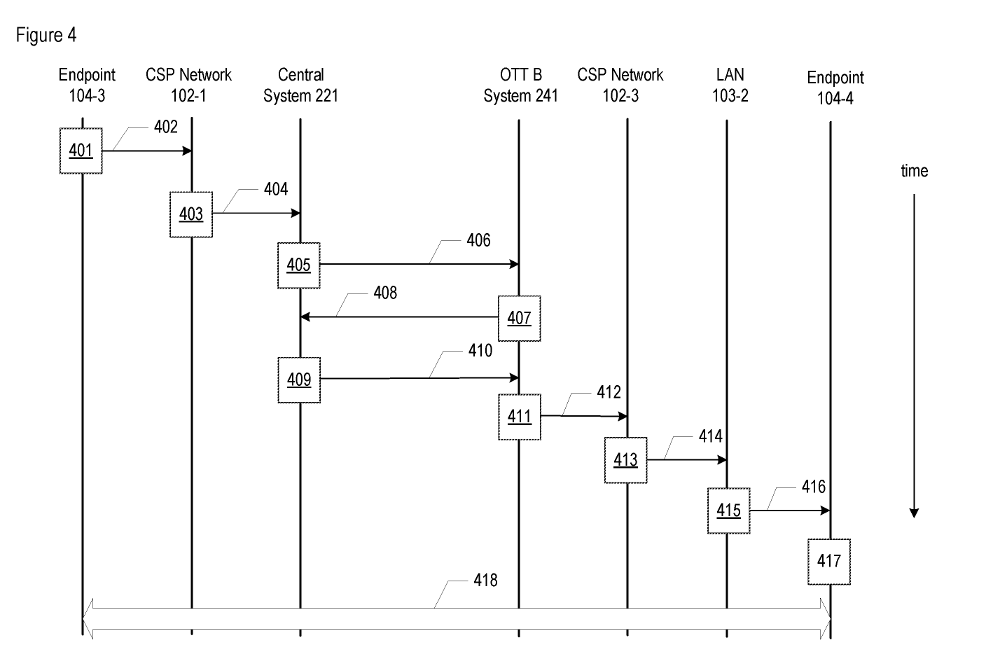

FIGS. 4 through 6 depict message flow diagrams that are representative of three respective operating scenarios of telecommunications system 100. Each operating scenario features a technique for routing a call from an originating endpoint of a calling party to a terminating endpoint of a called party.

As depicted in FIGS. 4 through 6, the processes performed by telecommunications system 100 of the illustrative embodiment are depicted in the drawings as being performed in a particular order. It will, however, be clear to those skilled in the art, after reading this disclosure, that such operations can be performed in a different order than depicted or can be performed in a non-sequential order (e.g., in parallel, etc.). In some embodiments of the present invention, some or all of the depicted processes might be combined or performed by different devices than depicted. In some embodiments of the present invention, some of the depicted processes might be omitted.

Furthermore, for pedagogical purposes, a particular set of endpoints, networks, and servers are depicted as participating in the message flows. As those who are skilled in the art will appreciate, however, after reading this specification, other elements within telecommunications system 100 can participate in the message flows described herein.

FIG. 4 depicts a message flow diagram of the salient processes for routing a call from an originating endpoint of a calling party to a terminating endpoint of a called party based on one or more predetermined characteristics in an access network of the called party, in accordance with the illustrative embodiment of the present invention.

In accordance with process 401, originating endpoint 104-3 detects its user attempting to place a call and, as a result, transmits via its access network message 402 comprising a dialed number, to CSP network 102-1. In some embodiments of the present invention, this is referred to as a “B-Number.”

In accordance with process 403, CSP network 102-1, in response to receiving message 402, forwards the dialed number via message 404 to network 220, which routes the message to computer system 221.

In accordance with process 405, computer system 221 processes the received indication of a call from originating endpoint 104-3, including the dialed number. Processes 405 through 409, as well as the related messages, are reflected in FIG. 7 as part of method 700. For instance, in response to receiving message 404, computer system 221 queries OTT B computer system 241 via message 406.

In accordance with process 407, OTT B system 241, in response to receiving message 406, retrieves information in its database about the OTT subscriber being called by the calling party of endpoint 104-3. It provides the retrieved information to computer system 221 via message 408.

In accordance with process 409, computer system 221, in response to receiving message 408, assesses the OTT B service of the called party. In doing so, computer system 221 determines whether to terminate the call i) via the OTT B service or ii) via the dialed number and without any OTT call service of the called party being involved. As depicted in FIG. 4, computer system 221 decides to terminate the call via the OTT B service; thus, system 221 transmits message 410 to OTT B computer system 241, providing calling information received from endpoint 104-3.

In accordance with process 411, computer system 241, in response to receiving message 410 sets up the call on the OTT B app on endpoint 104-4, in well-known fashion. This includes transmitting message 412 to CSP network 102-3, which is uninvolved with the call setup, other than to forward the received packets.

In accordance with process 413, CSP network 102-3 transmits message 414 to a router in LAN 103-2, an access network, in response to receiving message 412.

In accordance with process 415, the LAN 103-2 router transmits message 416 to terminating endpoint 104-4, in response to receiving message 414.

In accordance with process 417, terminating endpoint 104-4 commences the exchanging of data with originating endpoint 104-3 via data stream 418.

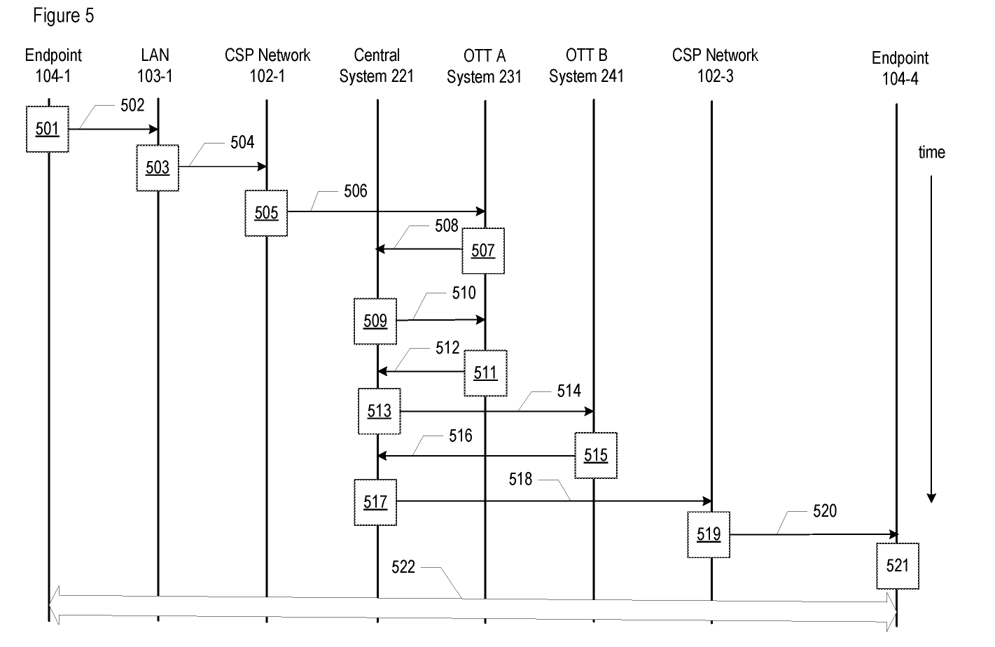

FIG. 5 depicts a message flow diagram of the salient processes for routing a call from an originating endpoint of a calling party to a terminating endpoint of a called party based on one or more predetermined characteristics in an access network of the calling party, in accordance with the illustrative embodiment of the present invention.

In accordance with process 501, originating endpoint 104-1 detects its user attempting to place a call. In particular, the user is using OTT A app running on endpoint 104-1, which detects the user attempting to place the call. As a result, endpoint 104-1 transmits message 502 comprising a dialed number, to LAN network 103-1, which is an access network.

In accordance with process 503, a router in LAN 103-1, in response to receiving message 502, forwards the dialed number via message 504 to computer system 221.

In accordance with process 505, CSP network 102-1, in response to receiving message 504, forwards the dialed number via message 506 to OTT A computer system 231, the OTT service platform of the calling party. In some embodiments of the present invention, the dialed number instead gets forwarded directly to system 221 via OTT A computer system 231.

In accordance with process 507, computer system 231 processes the received indication of a call from originating endpoint 104-1, by forwarding the indication with dialed number to computer system 221 in message 508.

In accordance with process 509, computer system 221 processes the received indication of a call from originating endpoint 104-1, including the dialed number and an indication of OTT A being used to originate the call. Processes 509 through 517, as well as the related messages, are reflected in FIG. 7 as part of method 700. For instance, in response to receiving message 508 and the indication that OTT is being used to originate the call, computer system 221 queries OTT A computer system 231 via message 510. Optionally, computer system 221 also queries OTT B computer system 241 (i.e., a candidate terminating OTT service) in accordance with process 513 via message 514.

In accordance with process 511, OTT A system 231, in response to receiving message 510, retrieves information in its database about the OTT subscriber calling from endpoint 104-1. It provides the retrieved information to computer system 221 via message 512.

In accordance with process 515, OTT B system 241, in response to receiving message 514, retrieves information in its database about the OTT subscriber being called by the calling party of endpoint 104-1. It provides the retrieved information to computer system 221 via message 516.

In accordance with process 517, computer system 221, in response to receiving at least message 512, assesses the OTT A service of the calling party. In some embodiments of the present invention, computer system 221, in response to receiving message 516, assesses the OTT B service of the called party as well. In doing so, computer system 221 determines whether to terminate the call i) via the OTT B service or ii) via the dialed number and without any OTT call service of the called party being involved. As depicted in FIG. 5, computer system 221 decides to terminate the call without using any OTT call service; thus, system 221 transmits message 518 to CSP network 102-3, providing calling information received from endpoint 104-1.

In accordance with process 519, CSP network 102-3, in response to receiving message 518 including the dialed number, sets up the call and on its own access network (e.g., mobile network, PSTN network, VoIP network, etc.), in well-known fashion. This includes transmitting message 520 to endpoint 104-4.

In accordance with process 521, terminating endpoint 104-4 commences the exchanging of data with originating endpoint 104-1 via data stream 522.

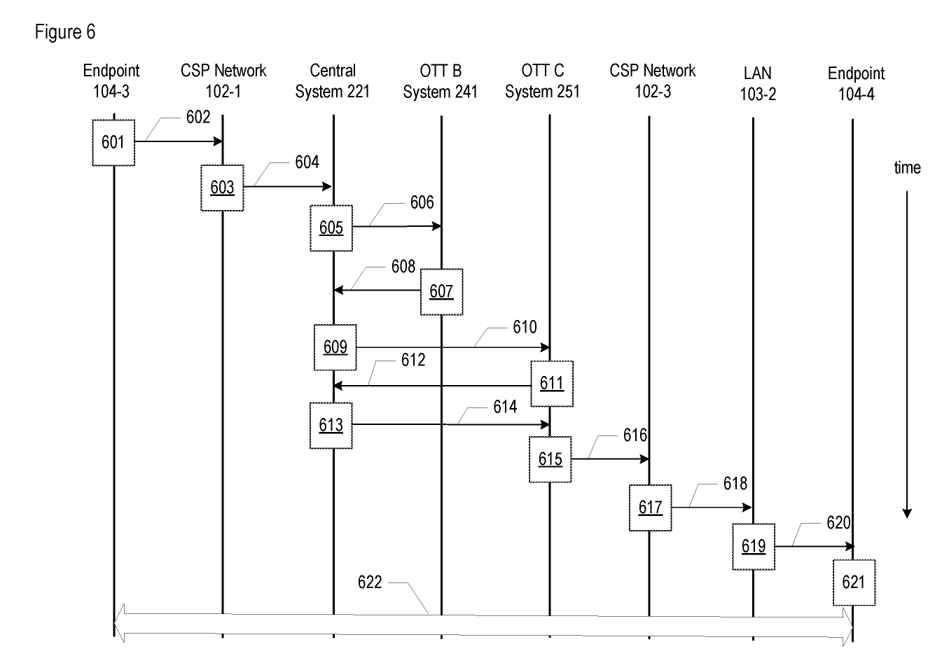

FIG. 6 depicts a message flow diagram of the salient processes for routing a call from an originating endpoint of a calling party to a terminating endpoint of a called party in which the call can be routed through one of multiple OTT call services of the called party, in accordance with the illustrative embodiment of the present invention.

In accordance with process 601, originating endpoint 104-3 detects its user attempting to place a call and, as a result, transmits via its access network message 602 comprising a dialed number, to CSP network 102-1.

In accordance with process 603, CSP network 102-1, in response to receiving message 602, forwards the dialed number via message 604 to network 220, which routes the message to computer system 221.

In accordance with process 605, computer system 221 processes the received indication of a call from originating endpoint 104-3, including the dialed number. Processes 605 through 613, as well as the related messages, are reflected in FIG. 7 as part of method 700. For instance, in response to receiving message 604, computer system 221 queries OTT B computer system 241 via message 606 and OTT C computer system 251 in accordance with process 609 via message 610.

In accordance with process 607, OTT B system 241, in response to receiving message 606, retrieves information in its database about the subscriber being called by the calling party of endpoint 104-3. It provides the retrieved information to computer system 221 via message 608.

In accordance with process 611, OTT C system 251, in response to receiving message 610, retrieves information in its database about the subscriber being called by the calling party of endpoint 104-3. It provides the retrieved information to computer system 221 via message 612.

In accordance with process 613, computer system 221, in response to receiving messages 608 and 612, assesses respectively the OTT B and OTT C services of the called party. In doing so, computer system 221 determines whether to terminate the call i) via the OTT B service or ii) via the OTT C service. In some embodiments of the present invention, computer system 221 also determines whether to terminate the call via any OTT service at all and instead terminate via the dialed number without any OTT call service of the called party being involved. As depicted in FIG. 6, computer system 221 decides to terminate the call via the OTT C service; thus, system 221 transmits message 614 to OTT C computer system 251, providing calling information received from endpoint 104-3.

In accordance with process 615, computer system 251, in response to receiving message 614 sets up the call on the OTT C app on endpoint 104-4, in well-known fashion. This includes transmitting message 616 to CSP network 102-3, which is uninvolved with the call setup, other than to forward the received packets.

In accordance with process 617, CSP network 102-3 transmits message 618 to a router in LAN 103-2, an access network, in response to receiving message 616.

In accordance with process 619, the LAN 103-2 router transmits message 620 to terminating endpoint 104-4, in response to receiving message 618.

In accordance with process 621, terminating endpoint 104-4 commences the exchanging of data with originating endpoint 104-3 via data stream 622.

FIGS. 7 through 12 depict flowcharts that are representative of at least some of the tasks performed by computer system 221 in routing a call from an originating endpoint of a calling party to a terminating endpoint of a called party, possibly through an OTT call service.

As depicted in the figures below, the tasks performed by computer system 221 of the illustrative embodiment are depicted in the drawings as being performed in a particular order. It will, however, be clear to those skilled in the art, after reading this disclosure, that such operations can be performed in a different order than depicted or can be performed in a non-sequential order (e.g., in parallel, etc.). In some embodiments of the present invention, some or all of the depicted tasks might be combined or performed by different devices than depicted. In some embodiments of the present invention, some of the depicted tasks might be omitted.

FIG. 7 depicts at least some of the salient tasks associated with method 700, in accordance with the illustrative embodiment of the present invention. Method 700 reflects a subset of the processes described above and in regard to FIGS. 4 through 6.

At task 705, computer system 221 receives an indication of a call from an originating endpoint (e.g., endpoint 104-1, endpoint 104-3, etc.), including a dialed number.

At task 710, computer system 221 determines one or more OTT call services of the called party, based on the dialed number. For example and without limitation, system 221 can use a database that maintains, for each subscriber, the OTT call services associated with that subscriber. In this case, system 221 determines the subscriber corresponding to the dialed number received and retrieves indications of the OTT call service or services from its database.

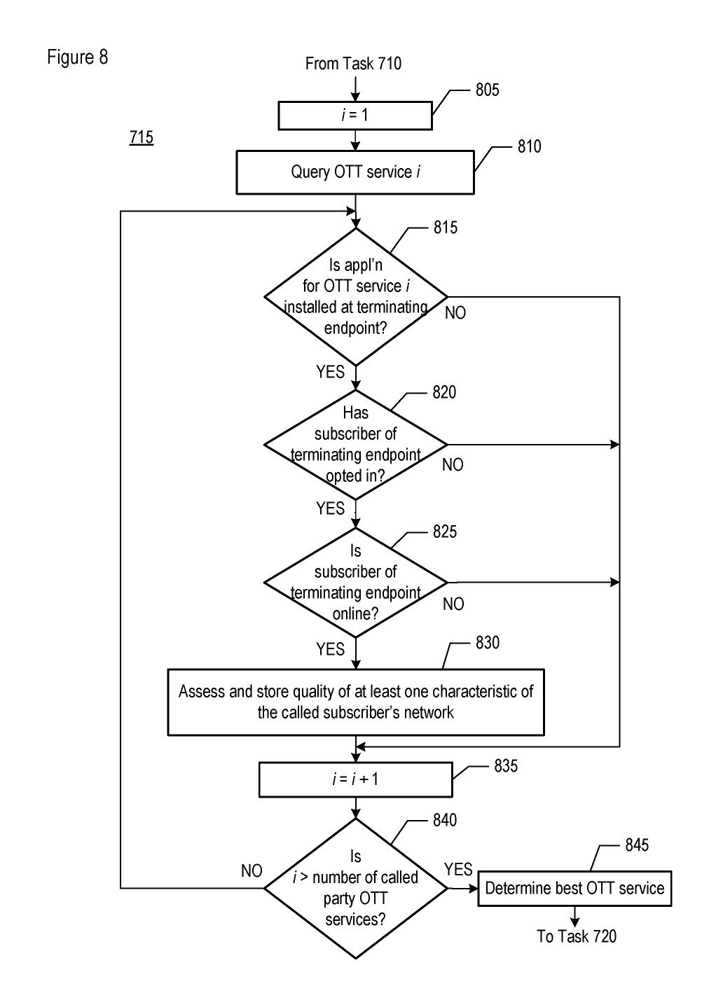

At task 715, computer system 221 queries and assesses the one or more OTT call services of the called party that were determined at task 710. Task 715 is described below in with respect to FIG. 8.

At task 720, computer system 221 determines whether the calling party is using an OTT call service to originate the call. If the calling party is using an OTT service, the control of execution proceeds to task 730. Otherwise, control of execution proceeds to task 725.

At task 725, computer system 221 determines whether the quality of a call would be acceptable if terminated via an OTT call service, based on the results from task 715. If the quality is assessed at task 715 as being acceptable, control of execution proceeds to task 740. Otherwise, control of execution proceeds to task 745.

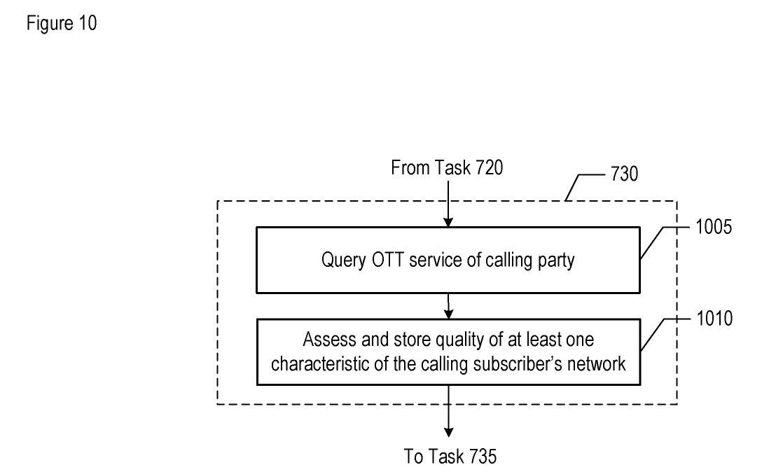

At task 730, computer system 221 queries and assesses the OTT call service being used in the present call by the calling party. Task 730 is described below in with respect to FIG. 10.

At task 735, computer system 221 determines, in the case where the originating endpoint is already using an OTT call service, whether the quality of a call, if also terminated via an OTT call service, would be acceptable. The quality is assessed based on the results from task 730 and, at least in some embodiments, the results from task 715. In some embodiments, the quality is assessed based only on the results from task 730. In some other embodiments, the quality is assessed by determining that the performance of the originating OTT call service exceeds a predetermined threshold and, only then, by considering the results from task 715 as well. As those who are skilled in the art will appreciate after reading this specification, other relationships between originating OTT call service and terminating OTT call service can be considered, in terms of assessing the anticipated quality of a call that is being set up. If the quality is assessed as being acceptable, control of execution proceeds to task 740. Otherwise, control of execution proceeds to task 745.

At task 740, computer system 221 terminates the call to a terminating endpoint (e.g., endpoint 104-4, etc.) of the called party via the best called-party OTT service, based on the assessment at task 715. Control of execution then ends.

At task 745, computer system 221 terminates the call to the called endpoint via the dialed number. Control of execution then ends.

FIG. 8 depicts at least some of the salient subtasks associated with task 715. At task 805, index i is set equal to 1.

At task 810, computer system 221 queries OTT service i. For example, OTT service 1 can correspond to OTT B in FIGS. 4-6, OTT service 2 can correspond to OTT C, and so on. In querying the i^{th} OTT service to which the called party has subscribed, system 221 retrieves information including that which is discussed below. The information also includes the telephone number (or other routing information) used by the particular subscriber of the OTT service, which can be used later on to terminate the call to the proper endpoint and/or service.

In some embodiments of the present invention, at least some of the information below is already known at computer system 221.

At task 815, computer system 221 determines whether an app for OTT app i is installed at a candidate terminating endpoint of the called party. In some embodiments of the present invention, the terminating endpoint corresponds to the dialed number. If the app is installed, then control of execution proceeds to task 820. If not, then control of execution proceeds to task 835.

At task 820, computer system 221 determines whether the called party subscriber of OTT service i has consented to receive calls on the app (i.e., has “opted in”). If the subscriber has so consented, then control of execution proceeds to task 825. If not, then control of execution proceeds to task 835.

At task 825, computer system 221 determines whether the called party subscriber of OTT service i is online with that app. If the subscriber is online, then control of execution proceeds to task 830. If not, then control of execution proceeds to task 835.

At task 830, computer system 221 assesses and stores the quality that is based on at least one characteristic of the access network through which service would be delivered to the called party via OTT service i. In accordance with the illustrative embodiment of the present invention, computer system 221 assesses access network quality in the following manner. System 221 queries, at task 810, OTT system 241 if querying the OTT B call service, in order to determine the type of wireless network that the candidate terminating endpoint (e.g., endpoint 104-4, etc.) is on. OTT system 241 returns the queried-for information, and based on the information returned to it, system 221 determines a quality scoring of the OTT call service. The following is a listing of such scores, for example and without limitation:
i. score of 0 if subscriber is offline or has opted out of receiving calls,
ii. score 1 if subscriber's network is 2G,
iii. score 2 if subscriber's network is 2.5G,
iv. score 3 if subscriber's network is 3G and is in a developing visited country,
v. score 4 if subscriber's network is 3G and is in a developed visited country,
vi. score 5 if subscriber's network is 4G,
vii. score 6 if subscriber's network is WiFi (i.e., a local area network),
viii. score 7 if subscriber's network is LTE, and
ix. score 8 if subscriber's network is LTE-A.

As those who are skilled in the art will appreciate after reading this specification, a different set of scores can be used that are based on a different set of cellular technologies, mobile networks, local area networks, classifications of countries/regions, classification of a geolocation other than the visited country, and so on. In some embodiments of the present invention, the country is not considered at all. Also, the quality score might be based on a different set of predetermined characteristics other than or in addition to the characteristics of mobile telecommunications technology generation (e.g., 2G, 2.5G, 3G, 4G, 5G, etc.) of the access network, whether the access network is WiFi-based, the geolocation (e.g., country, etc.) of the terminating endpoint, and so on.

In regard to basing the score on whether the subscriber's network is in a developed or developing country, one reason for scoring a 3G mobile network higher in a developed country is that the mobile network coverage and performance in a developed country tends to be more consistent than in a developing country. As those who are skilled in the art will appreciate after reading this specification, a different generation of mobile network than 3G (e.g., 2G, 2.5G, 4G, 5G, etc.) can be further assessed with respect to whether the network is in a developed or developing country.

In some embodiments of the present invention, computer system 221 accounts for features in and feature differences across different operating systems of the terminating endpoints. For Apple™ endpoints (e.g., smartphones, etc.), if there is no reliable network information, then system 221 can use the WiFi-and-Data flag (in iOS) with the following logic:
i. score of 0 if subscriber is offline or has opted out of receiving calls,
ii. score of 3 if subscriber has data in a developing visited country,
iii. score of 4 if subscriber has data in a developed visited country, and
iv. score of 6 if subscriber's network is WiFi.

As described above, computer system 221 uses a developed-countries list (e.g., a “whitelist”) for scoring purposes and to distinguish from developing countries (e.g., a “blacklist”). This list can change over time and is updated accordingly. In some embodiments, computer system 221 can use a developing countries list, or a different type of countries list entirely.

In the case of a called subscriber who is roaming outside his home area, the country that is considered is based on the country visited by the roamer. The visited country can be determine in one or more different ways, such as via the geolocation of the roaming terminal and/or via obtaining the IP address being used by the roaming terminal. The geolocation can be represented as geographical coordinates, an address on a road, a city, a region, and so on, for example and without limitation. In some embodiments, a geolocation can be obtained via Global Positioning System (GPS) functionality at the endpoint and/or position determining equipment (PDE) somewhere in telecommunications system 100. Generally speaking, the location of the called subscriber can be used by one or all of these methods, in order to determine the terminal's disposition in relation to the countries list discussed above, regardless of whether the subscriber is roaming or not (i.e., in his home network).

In some embodiments of the present invention, computer system 221 also accounts for differences among the particular OTT call services. For example, the OTT B call service might require different network resources (e.g., bandwidth, etc.) than the OTT C call service; consequently computer system 221 might adjust the scoring of OTT B, either in absolute terms or relative to the score of OTT C, accordingly.

In some embodiments of the present invention, computer system 221 might also account for the cost of providing OTT call service via the OTT that is being assessed for quality. For example, OTT B might involve different charges than OTT C, might involve some charges versus none at all. The accounting for cost can be factored into the overall quality score for the particular OTT or can be kept separate from the quality score.

In some embodiments of the present invention, computer system 221 might check whether the particular conditions of the terminating endpoint's access network are currently adequate. For example, computer system 221 might probe the network by sending one or more packets, waiting for a reply, and assess the performance of the network by evaluating the sent and received packets, in well-known fashion. In this way or in a different way, computer system 221 might evaluate for specific quality parameters such as, but not limited to, packet delay, packet loss, jitter, dropped calls, and so on. Also, computer system 221 might use historical data provided by the particular OTT being assessed, in terms of the aforementioned quality parameters or other parameters.

Computer system 221, in some embodiments, compares the score against a predetermined threshold. The quality is determined to be acceptable if the score exceeds the threshold. The results are saved and used in performing tasks 725 and 735.

As those who are skilled in the art will appreciate after reading this specification, computer system 221 can maintain and use a single, predetermined threshold or can maintain and use a different threshold for each service level supported, such as budget level, retail level, enterprise (business) level, video quality level (requiring still more bandwidth), for example and without limitation. In other words, a lower score might be acceptable to put a call through to the OTT call service for a budget service level, while only a higher score might be acceptable for higher service levels (e.g., video, etc.).

In some embodiments of the present invention, a predetermined characteristic of an access network is compared against a predetermined threshold, instead of the quality score of the particular OTT call service being compared against a predetermined threshold.

Computer system 221 stores and maintains the values of at least some of the aforementioned parameters, in a database such as in a format depicted in FIG. 9. Database record 911 corresponds to the parameter values for the OTT B call service for the particular subscriber being called, database record 912 corresponds to the OTT C call service for the particular subscriber being called, and so on.

At task 835, computer system 221 increments the index i.

At task 840, computer system 221 determines whether the index i is greater than the number of called party OTT services identified at task 710. If so, meaning that no more apps are to be assessed, control of task execution proceeds to task 845. Otherwise, control of task execution proceeds back to task 815.

At task 845, computer system 221 determines the “best” OTT call service through which to terminate the call to the called party, based on the score determined in accordance with task 830. In accordance with the illustrative embodiment of the present invention, the OTT call service with the highest score is the best service through which to deliver the call. In some alternative embodiments of the present invention, a different criterion is used.

Control of task execution then proceeds to task 720.

FIG. 10 depicts at least some of the salient subtasks associated with task 730. At task 1005, computer system 221 queries and assesses the OTT call service of the calling party when calling using such an OTT service. In querying the OTT service to which the calling party has subscribed, system 221 retrieves information including that which is discussed below. In some embodiments of the present invention, at least some of the information below is already known at computer system 221.

At task 1010, computer system 221 assesses and stores the quality that is based on at least one characteristic of the network through which service is being provided to the calling party via OTT. In accordance with the illustrative embodiment of the present invention, computer system 221 assesses access network quality in the manner described above and in with respect to task 830, except that the assessment pertains to the calling party's OTT service (e.g., OTT A, etc.). As those who are skilled in the art will appreciate after reading this specification, in general the features described above and with respect to task 830 are applicable to task 1005, except that they pertain to the calling party and the originating endpoint instead of the called party at a terminating endpoint. Furthermore, the OTT service is already being used by the calling party for the present call; accordingly, the purpose of task 1010 is to determine the effect that the originating OTT service has on the quality of using an OTT service to deliver the call to the terminating endpoint. In some embodiments of the present invention, this can be achieved, with little or no additional overhead, by assessing the call quality being experienced by the originating endpoint already using the OTT call service (e.g., via a real-time performance test, etc.).

As part of determining whether the overall quality is acceptable, the quality score associated with the terminating endpoint's network and/or terminating OTT service is considered along with the quality score determined at task 1010 and associated with the originating endpoint's network and/or originating OTT service. In some embodiments of the present invention, the combined scores are compared against a predetermined threshold, in order to determine whether to use an OTT service to deliver the call to the terminating endpoint of the called party. Each combined score can be calculated by adding the individual scores of the originating and terminating OTT services, for example and without limitation. The results of this comparison are saved and used in accordance with task 735.

Control of task execution then proceeds to task 735.

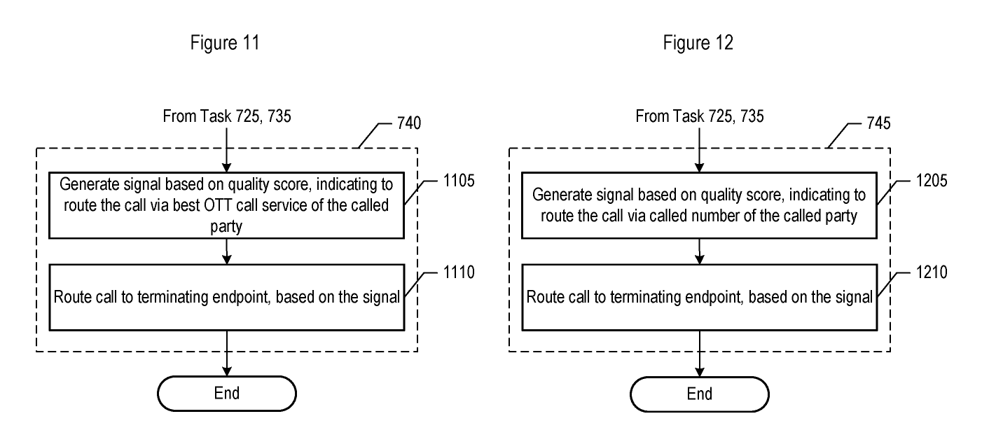

FIG. 11 depicts at least some of the salient subtasks associated with task 740. At task 1105, computer system 221 generates a signal based on the quality score determine above and with respect to tasks 715 and 730. In some embodiments of the present invention, the best OTT call service of the called party is defined as the called party's OTT call service having the highest quality score; however, as those who are skilled in the art will appreciate after reading this specification, a different definition can be applied. The signal indicates to route the call via a particular OTT call service (e.g., the best OTT service, etc.) of the called party. The dialed number is mapped to routing information associated with the selected OTT call service, as described above, and then the call is routed in well-known fashion.

At task 1110, computer system 221 transmits the signal to the particular networking device or devices, which then route the call to the terminating endpoint based on the signal.

FIG. 12 depicts at least some of the salient subtasks associated with task 745. At task 1205, computer system 221 generates a signal based on the quality score determine above and with respect to tasks 715 and 730. The signal indicates to route the call via the dialed number of the called party (i.e., not through an OTT service).

At task 1210, computer system 221 transmits the signal to the particular networking device or devices, which then route the call to the terminating endpoint based on the signal.

It is to be understood that the disclosure teaches just one example of the illustrative embodiment and that many variations of the invention can easily be devised by those skilled in the art after reading this disclosure and that the scope of the present invention is to be determined by the following claims.

1. A system for connecting a call from an originating endpoint of a calling party to a terminating endpoint of a called party, comprising:
a computer system configured to:
receive a dialed number for the call when placed from the originating endpoint,
determine an over-the-top (OTT) call service subscribed to by the called party, wherein the OTT call service of the called party is accessible from the terminating endpoint via the Internet, and
generate a signal for controlling the call, wherein the signal indicates to route the call i) via the dialed number such that the call is switched via the terminating endpoint's local telecommunications service provider and access network or ii) via the OTT call service of the called party, based on whether the call is placed from the originating endpoint through an OTT call service of the calling party; and
a networking device configured to route the call to the terminating endpoint, based on the signal.

2. The system of claim 1 wherein the OTT call service of the calling party is delivered through a first access network, and wherein the signal is further based on a first predetermined characteristic of the first access network.

3. The system of claim 1 wherein the OTT call service of the called party is delivered through a second access network, and wherein the signal is further based on a second predetermined characteristic of the second access network.

4. The system of claim 2 wherein the first predetermined characteristic is network quality, and wherein the signal is further based on the network quality of the first access network.

5. The system of claim 2 wherein the first predetermined characteristic is the mobile telecommunications technology generation of the first access network.

6. The system of claim 2 wherein the first predetermined characteristic is whether the first access network is WiFi-based.

7. A method for connecting a call from an originating endpoint of a calling party to a terminating endpoint of a called party, comprising:
receiving, by a computer system, a dialed number for the call when placed from the originating endpoint;
determining, by the computer system, an over-the-top (OTT) call service subscribed to by the called party, wherein the OTT call service of the called party is accessible from the terminating endpoint via the Internet;
generating, by the computer system, a signal for controlling the call, wherein the signal indicates to route the call i) via the dialed number such that the call is switched via the terminating endpoint's local telecommunications service provider and access network or ii) via the OTT call service of the called party, based on whether the call is placed from the originating endpoint through an OTT call service of the calling party; and
routing the call to the terminating endpoint based on the signal.

8. The method of claim 7 wherein the OTT call service of the calling party is delivered through a first access network, and wherein the signal is further based on a first predetermined characteristic of the first access network.

9. The method of claim 7 wherein the OTT call service of the called party is delivered through a second access network, and wherein the signal is further based on a second predetermined characteristic of the second access network.

10. The method of claim 8 wherein the first predetermined characteristic is network quality, and wherein the signal is further based on the network quality of the first access network.

11. The method of claim 8 wherein the first predetermined characteristic is the mobile telecommunications technology generation of the first access network.

12. The method of claim 8 wherein the first predetermined characteristic is whether the first access network is WiFi-based.

13. A system for connecting a call from an originating endpoint of a calling party to a terminating endpoint of a called party, comprising:
a computer system configured to:
receive a dialed number for the call when placed from the originating endpoint through an over-the-top (OTT) call service of the calling party accessed from the originating endpoint via a first access network,
determine an OTT call service subscribed to by the called party, and
generate a signal for controlling the call, wherein the signal indicates to route the call i) via the dialed number such that the call is switched via the terminating endpoint's local telecommunications service provider and access network or ii) via the OTT call service of the called party, based on a first predetermined characteristic of the first access network; and
a networking device configured to route the call, based on the signal.

14. The system of claim 13 wherein the OTT call service of the called party is delivered through a second access network, and wherein the signal is further based on a second predetermined characteristic of the second access network.

15. The system of claim 13 wherein the first predetermined characteristic is network quality, and wherein the signal is further based on the network quality of the first access network.

16. The system of claim 13 wherein the first predetermined characteristic is the mobile telecommunications technology generation of the first access network.

17. The system of claim 13 wherein the first predetermined characteristic is whether the first access network is WiFi-based.

18. A method for connecting a call from an originating endpoint of a calling party to a terminating endpoint of a called party, comprising:
receiving, by a computer system, a dialed number for the call when placed from the originating endpoint through an over-the-top (OTT) call service of the calling party accessed from the originating endpoint via a first access network;
determining, by the computer system, an OTT call service subscribed to by the called party;
generating, by the computer system, a signal for controlling the call, wherein the signal indicates to route the call i) via the dialed number such that the call is switched via the terminating endpoint's local telecommunications service provider and access network or ii) via the OTT call service of the called party, based on a first predetermined characteristic of the first access network; and
routing the call to the terminating endpoint based on the signal.

19. The method of claim 18 wherein the OTT call service of the called party is delivered through a second access network, and wherein the signal is further based on a second predetermined characteristic of the second access network.

20. The method of claim 18 wherein the first predetermined characteristic is network quality, and wherein the signal is further based on the network quality of the first access network.

21. The method of claim 18 wherein the first predetermined characteristic is the mobile telecommunications technology generation of the first access network.

22. The method of claim 18 wherein the first predetermined characteristic is whether the first access network is WiFi-based.
